(19) United States
(12) Patent Application Publication
(10) Pub. No.: US 2025/0134136 A1
(43) Pub. Date: May 1, 2025

(54) Textured Plant Protein Pasta Product and Method

(71) Applicant: Glanbia Nutritionals Limited, Kilkenny (IE)

(72) Inventor: Jason Demmerly, Twin Falls, ID (US)

(73) Assignee: Glanbia Nutritionals Limited, Kilkenny (IE)

(21) Appl. No.: 18/833,738

(22) PCT Filed: Feb. 17, 2023
(86) PCT No.: PCT/US2023/013310

§ 371 Date: Jul. 26, 2024

Related U.S. Application Data
(60) Provisional application No. 63/311,909, filed on Feb. 18, 2022.

(51) Int. Cl. A23J 3/34; A23J 3/14; A23J 3/26

(52) U.S. Cl. CPC A23J 3/346; A23J 3/14; A23J 3/26

(57) ABSTRACT

Disclosed is a method for producing textured plant protein pasta products. The method provides a means for forming pasta products of various kinds having at least about 55 percent protein by weight. The resulting products can be formed in a variety of sizes and shapes and used in a variety of applications for which pasta is commonly used.

### CROSS-REFERENCE TO RELATED APPLICATION

This application claims priority to U.S. Provisional Application No. 63/311,909 that was filed on Feb. 18, 2022. The entire content of the application referenced above is hereby incorporated by reference herein.

### FIELD OF THE INVENTION

The invention relates to high-protein pasta products and methods for making those products. More specifically, the invention relates to methods for making pasta from textured plant protein and products made by those methods.

### BACKGROUND OF THE INVENTION

Pasta is a food product generally made from unleavened dough consisting of ground durum wheat and at least one liquid. The dough often comprises durum wheat flour, salt, and water, milk, and/or eggs. Consumers generally enjoy pasta in its various forms without realizing that something as simple as flour and water can have such a unique chemical functionality that it gives it the versatility, processability, and other features that both consumers and manufacturers value.

Durum wheat has generally been used for traditional pastas because of its high gluten content and low moisture, gluten providing important properties to the products. Wheat flours mainly consist of carbohydrates and protein, with some fiber. They are classified based on their gluten. When a liquid ingredient such as milk or water comes in contact with wheat flour, the gluten proteins in the flour unravel and hook onto one another. These bonds are relatively strong and create a network of interconnected gluten strings that hold the dough together and give it structure. This allows it to be extruded to form the familiar shapes of spaghetti, penne, fusilli, macaroni, etc. It also allows it to be cooked, frozen, reheated, etc., without falling apart. However, it is not only the gluten that gives pasta its familiar texture, taste, and functionality. Carbohydrates (e.g., starch) play a significant role, as well. Within the gluten network that forms during pasta making are starch granules, which can swell and burst as the pasta is cooked. This is controlled, to some extent, by the gluten network. In pasta made from durum wheat, the gluten network entraps the starch molecules. As the starch granules are heating during cooking, they eventually can swell and burst-releasing the sticky starch. When gluten is present at a sufficient level, the entrapment of those starch molecules significantly reduces the starch release and resulting stickiness. In the absence of sufficient gluten, the product can be stickier when cooked and can stiffen as the cooked product cools down.

Amylase accounts for about 25% of the total starch in starch granules, and starches from durum wheat have slightly higher amylase than do other common wheat starches. In some studies, reduced amylase content has been demonstrated to produce a softer pasta with inferior texture. Variation in the starch granule distribution and amylase content while maintaining protein content and composition the same, has also been shown to affect pasta quality (Soh, H. N. et al., Effect of Starch Granule Size Distribution and Elevated Amylase Content on Durum Dough Rheology and Spaghetti Cooking Quality, Cereal Chem. 83 (5): 513-519).

Pasta's global popularity is due in part to its versatility and convenience. It can be prepared in a very short time and its neutral flavor allows it to be combined with a variety of different kinds of sauces, meats, vegetables, etc., so the options for pasta recipes seem almost endless. It can be rolled into sheets, cut into strips/noodles, or extruded to form any of a large number of different shapes. Pasta has also been easier to commercialize than many foods. It is relatively easy to mass produce, has a long shelf life, and is easy to transport. All of these properties relate directly to its unique combination of gluten proteins (glutenin and gliadin) and starch. In 2018, 14.5 million tons of pasta were produced worldwide, with revenues of over $99 Billion USD and an expected growth rate of 2.7% annually. In the US market alone, the pasta market generated over 2.8 Billion USD and sustained a 3% growth rate over the 2009-2019 decade. The higher-protein pasta market, while still relatively small, averaged a 7.2% growth rate over the same time frame with annual revenue of nearly 90 million USD. That market is expected to hit 115 million USD by 2024, with market growth averaging almost 15% for 2019 and 2020.

Gluten-free (GF) pasta products have become very popular, even among people who are not gluten-sensitive. However, Marti et al. noted that “[u]nfortunately, most of them exhibit poor cooking quality, particularly when compared with their wheat counterparts. Moreover, many GF products are nutritionally inferior, i.e. poorer in minerals and bio-components, to the wheat-based foods they are intended to replace. These findings suggest that more attention should be paid to the nutritional and sensory quality of GF products.” (Marti, A. and M. Pagani, What can play the role of gluten in gluten-free pasta? Trends in Food Sci and Technol 31 (2013) 63-71.)

Higher-protein pastas have also become more popular, as many people try to incorporate more protein-especially protein that is plant-based-into their diets. Commercial pastas with high protein contents include a wide range of ingredients such as soy protein, pea protein, lentils, eggs, egg white, inulin, caseinate, and gluten. All of these products present some challenges, with many of them giving the pasta a grainy texture and less elasticity than that of full-gluten low-protein products. Formulating high protein pasta products generally involves producing malleable doughs with good elasticity using one or more plant proteins. The gels need to have the proper gel strength, viscosity, and texture throughout the forming, cooking, and rehydrating processes to effectively mimic the texture, taste, and functionality of traditional durum wheat-based pasta products.

When working with proteins to achieve desirable functionalities, it is important to note, as Akharume et al. noted, that “Proteins are complex biomolecules and their modification is not a ‘one size fits all’ approach. Depending on the functionality of interest, it is important to know the nature (whether in isolation or bound with other polymers) and structural properties of the protein ingredient as well the mechanism required to achieve a modified target functional property.” (Akharume, F., et al. Modification of plant proteins for improved functionality: A review. Compr Rev Food Sci Food Saf. 20 (2021) 198-224.) Protein sources are also very important, and in sometimes they can make a critical difference. “Commercial plant protein ingredients include protein flours (10 to 20% protein), protein concentrates (55 to 60%), and protein isolates (>80%). Generally, Pulses contain about 21 to 25% protein and cereals contain about 6 to 15% protein.” (Akharume, et al.)

To give one specific example, while pea protein is an attractive alternative for a variety of applications, its use has also presented some challenges. As Tulbek et al. noted, “Current research indicates that pea protein products tend to have weaker gel strength, viscosity, and texture compared to egg, soy, and meat proteins.” (Tulbek, M. C., et al. (2017). Pea: A Sustainable Vegetable Protein Crop. In S. R Nadathur, J. P. D. Wanasundara, & L. Scanlin (Eds.), Sustainable Protein Sources (pp. 145-164). Elsevier Inc. DOI. (http://dx.doi.org/10.1016/B978-0-12-802778-3.00009-3). Gluten, the protein associated with the viscoelastic properties that contribute to the desirable characteristics of good pasta, has generally not been easy to replace because, especially where protein is concerned, the parts are not automatically interchangeable.

The food industry has responded to consumer wishes and needs in recent years by developing higher-protein, gluten-free pastas. However, if one looks closely at the ingredient panels for those products, it is clear that carbohydrate is still the dominant component. As explained in U.S. Pat. No. 8,747,935 (Villata et al.), pasta formulas containing large amounts of protein (e.g., 20 percent or more) make the pasta dough hard to extrude, producing a product exhibiting rubbery characteristics or an extremely firm texture. Consumers prefer a firm, but chewy product—but “rubbery” is not a desirable attribute in pasta products. Villata addressed the issue by adding a texture-modifying agent to minimize gluten development, but still relied on significantly more wheat flour than protein in the resulting products. US2021/0007376A1 (Arla Foods) is titled “High Protein Pasta.” Like most of the patents and applications in this field, that disclosure describes the products in terms of “at least about_” percent protein, but a thorough reading of the disclosures demonstrate that even when using a protein such as their microparticulated and denatured whey protein, the amount of protein in the product is still significantly lower than the amount of carbohydrate. For the five samples listed in Table 7 (Paragraph [0337]), the ratios of protein to carbohydrate are 1/3, 1/2.4, 1/1.8, 1/1.5, and 1/1.25, respectively. Doud et al. (WO2005/120252 A1) did produce a pasta product having higher levels of protein, using a combination of “glutinous” protein and “globular” protein. However, the preferred “glutinous” protein is wheat gluten, which is not suitable for gluten-free products.

A wide variety of gluten-free and legume or vegetable-based pastas are commercially available, all trying to meet consumer demands or dietary needs. Table 1 lists many of these products and provides protein-to-carbohydrate ratios for each product.

TABLE 1
Commercially Available Gluten-Free or Grain-Free Pastas

| | | | | | | | | Pro/Carb |
|---|---|---|---|---|---|---|---|---|
| Product | Ingredients | Serving | | Protein | | Carb | | Ratio |
| Barilla ® | Corn Flour, Rice Flour, | 56 | g | 4 | g | 44 | g | 1 to 11 |
| Gluten Free | Mono and Diglycerides | | | | | | | |
| Elbows | | | | | | | | |
| La | Corn Flour, Emulsifier: | 62.5 | g | 4 | g | 45 | g | 1 to 11.25 |
| Veneziane ® | Mono and Diesters of | | | | | | | |
| Gluten Free | Fatty Acids of Vegetable | | | | | | | |
| Ditalini Corn | Origin | | | | | | | |
| Pasta | | | | | | | | |
| Jovial ® | Organic Cassava Flour, | 57 | g | 1 | g | 49 | g | 1 to 49 |
| Organic | Water | | | | | | | |
| Grain-Free | | | | | | | | |
| Cassava | | | | | | | | |
| Fusilli | | | | | | | | |
| Pasta | | | | | | | | |
| Jovial ® | Organic Brown Rice Flour, | 57 | g | 5 | g | 44 | g | 1 to 8.8 |
| Organic | Water | | | | | | | |
| Brown Rice | | | | | | | | |
| Farfalle Pasta | | | | | | | | |
| Jovial ® | Organic Brown Rice, | 57 | g | 5 | g | 40 | g | 1 to 8 |
| Organic | Organic Eggs | | | | | | | |
| Egg Tagliatelle | | | | | | | | |
| Gluten Free | | | | | | | | |
| Pasta | | | | | | | | |
| Ronzoni ® | White Rice Flour, Brown | 56 | g | 4 | g | 44 | g | 1 to 11 |
| Gluten Free | Rice Flour, Corn Flour, | | | | | | | |
| Rotini Pasta | Quinoa Flour, Mono and | | | | | | | |
| | Diglycerides | | | | | | | |
| Bionaturae ® | Organic Brown Rice Flour, | 57 | g | 5 | g | 42 | g | 1 to 5.25 |
| Organic Gluten | Organic White Rice Flour, | | | | | | | |
| Free Fusilli | Organic Yellow Lentil | | | | | | | |
| ZenB ® Penne | Whole Yellow Peas | 56 | g | 12 | g | 36 | g | 1 to 3 |
| Pasta | | | | | | | | |
| Banza ® Rotini | Chickpeas, Tapioca, | 56 | g | 13 | g | 32 | g | 1 to 2.5 |
| | Pea Proteim Xanthan | | | | | | | |
| | Gum | | | | | | | |
| It's Skinny ™ | Konjac Powder, Oat | 100 | g | 0 | g | 0 | g* | |
| Spaghetti | Powder, Water, Calcium | | | | | | | |
| | Hydroxide | | | | | | | |
| Caulipower ® | Cauliflower, Corn | 94 | g | 2 | g | 50 | g | 1 to 25 |
| Linguine | Flour, Potato Starch, | | | | | | | |
| Cauliflower | Rice Flour, Lentil Flour, | | | | | | | |
| Pasta | Psyllium, Citrus Biber, | | | | | | | |
| | Sunflower Seed oil, | | | | | | | |
| | Guar Gum, Xanthan | | | | | | | |
| | Gum | | | | | | | |
| Tinkyada ® | Organic Brown Rice, | 56 | g | 4 | g | 44 | g | 1 to 11 |
| Gluten Free | Water | | | | | | | |
| Brown Rice | | | | | | | | |
| Spaghetti | | | | | | | | |
| Ancient | Red Lentil Flour, | 55 | g | 14 | g | 37 | g | 1 to 2.6 |
| Harvest ® | Organic Quinoa Flour | | | | | | | |
| Plant Based | | | | | | | | |
| Protein Pasta - | | | | | | | | |
| Red Lentil | | | | | | | | |
| Rotini | | | | | | | | |
| Capella's ® | Almond Flour, Eggs, | 41 | g | 4 | g | 15 | g | 1 to 3.75 |
| Almond Flour | Tapioca Flour, Xanthan | | | | | | | |
| Pasta - | Gum, Seas Salt | | | | | | | |
| Spaghetti | | | | | | | | |
| Delallo ® | Corn Flour, Rice Flour, | 55 | g | 4 | g | 44 | g | 1 to 11 |
| Gluten Free | Monoglycerides | | | | | | | |
| Lasagna | (Emulsifier) | | | | | | | |
| Nocca ® | Mashed Potatoes | 198 | g | 5 | g | 67 | g | 1 to 13.4 |
| Gnochi Potato | (Water, Potato Flakes | | | | | | | |
| Dumpling | [Potatoes, Emulsifier: | | | | | | | |
| Pasta (Original | Mono and Diglycerides | | | | | | | |
| Gluten Free) | of Fatty Acids, Natural | | | | | | | |
| | Flavors]), Rice Flour, | | | | | | | |
| | Potato Starch, Lactic | | | | | | | |
| | Acid, Potassium | | | | | | | |
| | Sorbate (As a | | | | | | | |
| | Preservative), Sprinkled | | | | | | | |
| | with Rice and Flour | | | | | | | |
| Delallo ® | 70% Corn Flour, 30% | 56 | g | 3 | g | 44 | g | 1 to 14.7 |
| Gluten Free | Rice Flour | | | | | | | |
| Orzo | | | | | | | | |
| Rustichella | Organic Green Pea Flour, | 100 | g | 22 | g | 55 | g | 1 to 2.5 |
| d'Abuzzo ® | Water | | | | | | | |
| Organic | | | | | | | | |
| Gluten- Free | | | | | | | | |
| Green Pea | | | | | | | | |
| Fusilli | | | | | | | | |
| Rustichella | Organic Corn Flour, | 56 | g | 3 | g | 44 | g | 1 to 14.7 |
| d'Abuzzo ® | Water | | | | | | | |
| Organic | | | | | | | | |
| Corn | | | | | | | | |
| Gluten-Free | | | | | | | | |
| Spaghetti Pasta | | | | | | | | |
| Rustichella | Organic Red Lentil | 100 | g | 25 | g | 52 | g | 1 to 2.1 |
| d'Abruzzo ® | Flour, Water | | | | | | | |
| Organic Red | | | | | | | | |
| Lentil Gluten | | | | | | | | |
| Free | | | | | | | | |
| Sedanini Pasta | | | | | | | | |
| Al dente Carb | Semolina Flour (Durum | 56 | g | 15 | g | 24 | g | 1 to 1.6 |
| Nada ® | Semolina Wheat, | | | | | | | |
| Fettuccine** | Niacin, Reduced Iron, | | | | | | | |
| | Thiamin Mononitrate, | | | | | | | |
| | Riboflavin, Folic Acid), | | | | | | | |
| | Wheat Gluten, Non- | | | | | | | |
| | GMO Digestive | | | | | | | |
| | Resistant Cornstarch, | | | | | | | |
| | Non-GMO Defatted Soy | | | | | | | |
| | Flour, Water, Whole | | | | | | | |
| | Eggs | | | | | | | |
| Corabella ® | Organic Green Pea Flour, | 56 | g | 11 | g | 37 | g | 1 to 3.4 |
| Green Pea | Water | | | | | | | |
| Penne Pasta - | | | | | | | | |
| Gluten Free | | | | | | | | |
| Organic | | | | | | | | |
| Seggiano ® | Organic Green Pea Flour | 100 | g | 23.1 | g | 56.7 | g | 1 to 2.5 |
| Organic | | | | | | | | |
| Gluten Free | | | | | | | | |
| Artisan Pasta - | | | | | | | | |
| Green Pea | | | | | | | | |
| Fusilli | | | | | | | | |

However, a need still exists for pasta products that (1) have more protein than carbohydrate, (2) can be easily processed to produce the various shapes that are known for pasta products, and (3) have the desired texture, mouthfeel, and general attributes that consumers associate with good pasta.

### SUMMARY OF THE INVENTION

The invention provides a method for producing high-protein pasta, the method comprising the steps of preparing a mixture comprising water, transglutaminase, and at least one plant protein to produce an admixture which forms a gelatinized protein cake having a protein content of at least about 50 percent by weight and processing the gelatinized protein cake with at least one extruder to produce at least one shaped gelatinized protein pasta. Various aspects of the invention include the step of drying the shaped gelatinized protein pasta at a drying temperature of from about 30 to about 400 degrees Fahrenheit, to produce a plant protein-based pasta product. The invention also relates to high-protein pasta products made by the method.

In various aspects of the invention, the plant protein is pea protein. In various aspects, the ratio of water to protein in the water/transglutaminase/protein admixture comprises from about 0.66:1 to about 1.25:1, by weight. In various aspects, the protein content of the admixture is at least about 55 percent, by weight. In various aspects the protein content of the admixture at least about 60 percent, by weight. In various aspects the protein content of the admixture is at least about 65 percent, by weight. In various aspects, the protein content of the admixture is at least about 70 percent, by weight. In various aspects, the transglutaminase is added at from about 0.001 percent to about 2 percent of the admixture, by weight. In various aspects of the invention, a pasta extruder is used to shape and form the finished high-protein pasta product.

The invention also relates to at least one pasta product comprising at least about 50 percent protein by weight. In various aspects, the at least one pasta product is a shaped gelatinized protein pasta product. In various aspects, the at least one pasta product is a substantially gluten-free product. In various aspects the at least one pasta product comprises at least about 55 percent protein, by weight. In various aspects the at least one pasta product comprises at least about 60 percent protein, by weight. In various aspects the at least one pasta product comprises at least about 65 percent protein, by weight. In various aspects, the at least one pasta product comprises at least about 70 percent protein, by weight.

### BRIEF DESCRIPTION OF THE DRAWINGS

FIG. 1 through FIG. 13 illustrate the effect of water-to-protein ratio in the admixture used to form the gelatinized protein cake. “Dry” noodles are those that have been subjected to a drying process, while “raw” noodles have been extruded, but not yet dried.

FIG. 1 is a photograph of dry spaghetti noodles produced using 0.03% transglutaminase and a water-to-protein ratio of 40:60, by weight. As this photo of the pasta post-drying illustrates, this ratio resulted a very dry-looking final pasta with a bumpy contour along the edges of the pasta.

FIG. 2 is a photograph of raw (not yet dried) spaghetti noodles produced using 0.03% transglutaminase and a water-to-protein ratio of 40:60. As this photo of the raw pasta prior to drying shows, this ratio resulted in dry-looking raw pasta with a mottled appearance and uneven contours along the edge of the pasta.

FIG. 3 is a photograph of dry spaghetti noodles produced using 0.03% transglutaminase and a water-to-protein ratio of 45:45. As this photo of the pasta post drying shows, this ratio resulted in a dry-looking final pasta with uneven contours along the edges of the pasta.

FIG. 4 is a photograph of raw spaghetti noodles produced using 0.03% transglutaminase and a water-to-protein ratio of 45:55. As this photo of the raw pasta shows, this ratio resulted in dry-looking raw pasta with a mottled appearance and uneven contours along the edge of the pasta.

FIG. 5 is a photograph of dry spaghetti noodles produced using 0.03% transglutaminase and a water-to-protein ratio of 50:50. As this photo of the pasta post-drying shows, this ratio resulted in a dry-looking final pasta, but the uneven contours have smoothed out along the edges of the pasta. At this water-to-protein ratio the mottled appearance is still noticeable in the dry pasta product.

FIG. 6 is a photograph of raw spaghetti noodles produced using 0.03% transglutaminase and a water-to-protein ratio of 50:50. As this photo of the raw pasta shows, this ratio resulted in a wetter-looking pasta, with a more evenly-colored appearance. Feathering is noticeable along the edge of the pasta.

FIG. 7 is a photograph of dry spaghetti noodles produced using 0.03% transglutaminase and a water-to-protein ratio of 55:45. As this photo of the pasta post-drying shows, this ratio resulted in a much more evenly colored pasta, with smoother edges.

FIG. 8 is a photograph of raw spaghetti noodles produced using 0.03% transglutaminase and a water-to-protein ratio of 55:45. As this photo of the raw pasta shows, this ratio resulted in a wetter-looking pasta with a more evenly-colored appearance. Feathering is significantly reduced along the edge of the pasta.

FIG. 9 is a photograph of dry spaghetti noodles produced using 0.03% transglutaminase and a water-to-protein ratio of 60:40. As this photo of the pasta post-drying shows, this ratio resulted in an evenly-colored pasta with smooth edges.

FIG. 10 is a photograph of raw spaghetti noodles produced using 0.03% transgutaminase and a water-to-protein ratio of 60:40. As this photo of the raw pasta shows, this ratio resulted in a wet-looking pasta with an evenly-colored appearance. Feathering was significantly reduced along the edge of the pasta.

FIG. 11 is a photograph of fusilli pasta produced by the method of the invention using 0.03% transglutaminase and a water-to-protein ratio of 45:55. As this photo illustrates, the pasta forms with good cohesiveness and a very recognizable spiral shape.

FIG. 12 is a photograph of rigatoni pasta produced by the method of the invention using 0.03% transglutaminase and a water-to-protein ratio of 45:55. As this photo illustrates, this pasta is also cohesive and has the characteristic shape of rigatoni.

FIG. 13 is a photograph of macaroni produced using 0.03% transglutaminase and a water-to-protein ratio of 45:55. In this case, the product has the hollow, curved shape expected of a macaroni pasta.

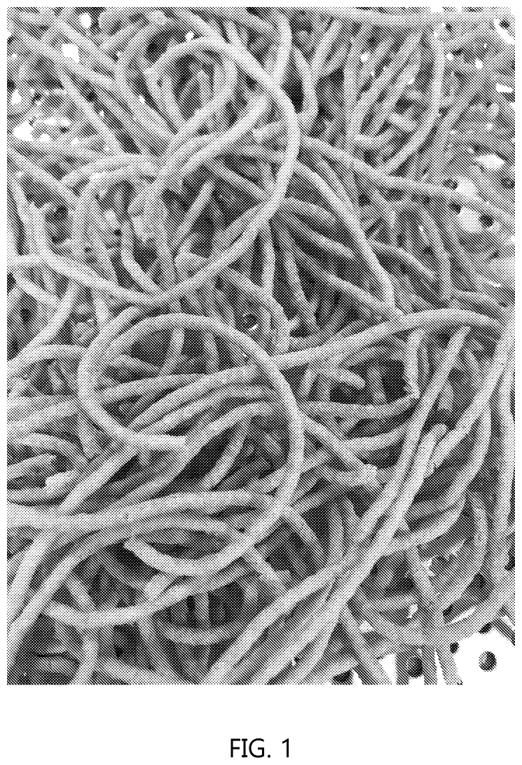

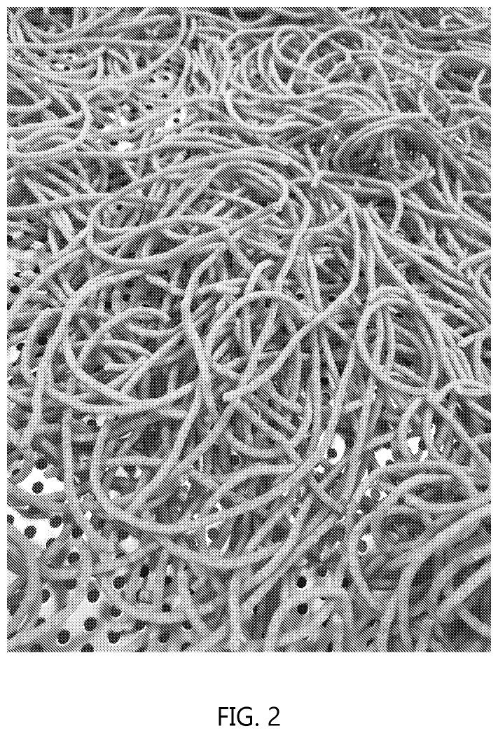

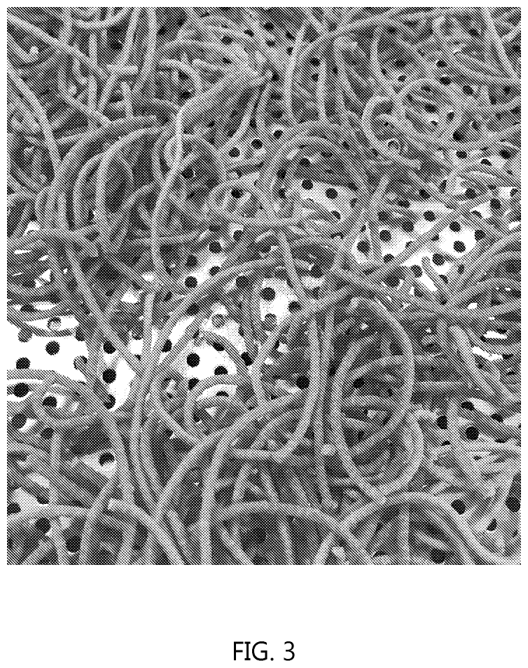

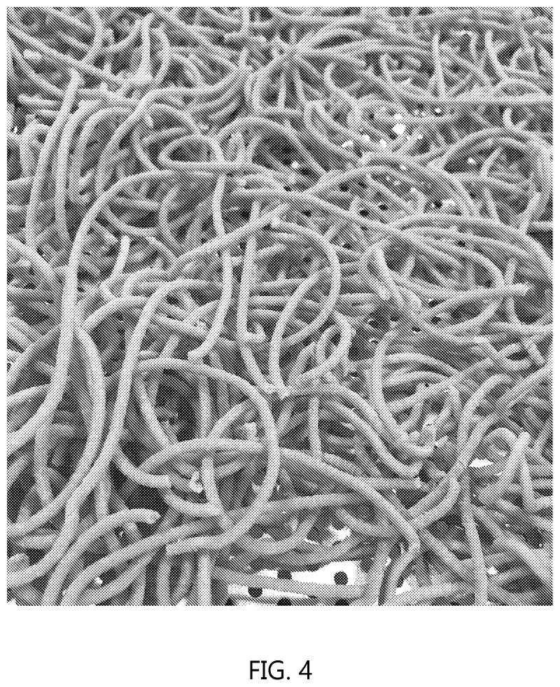

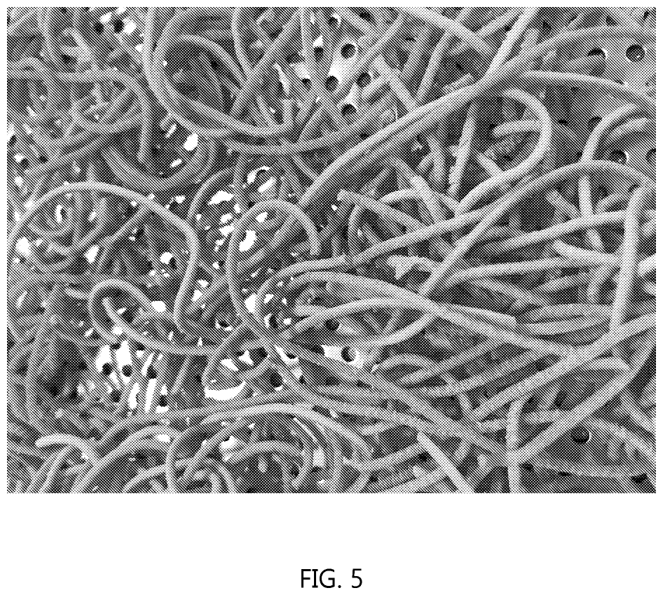

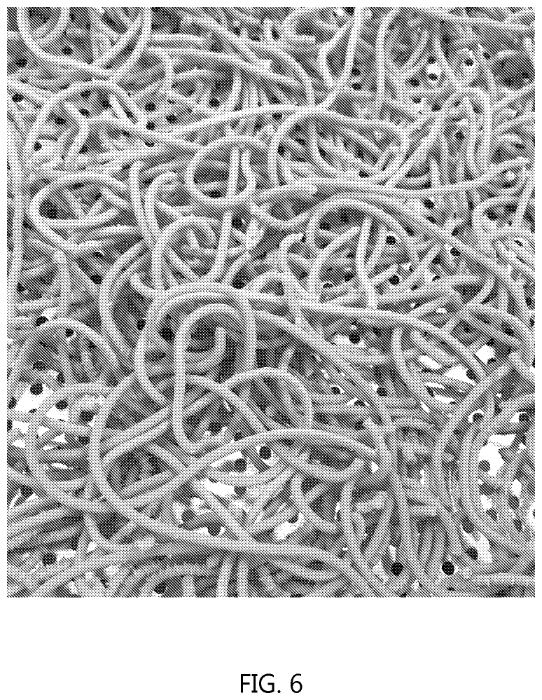

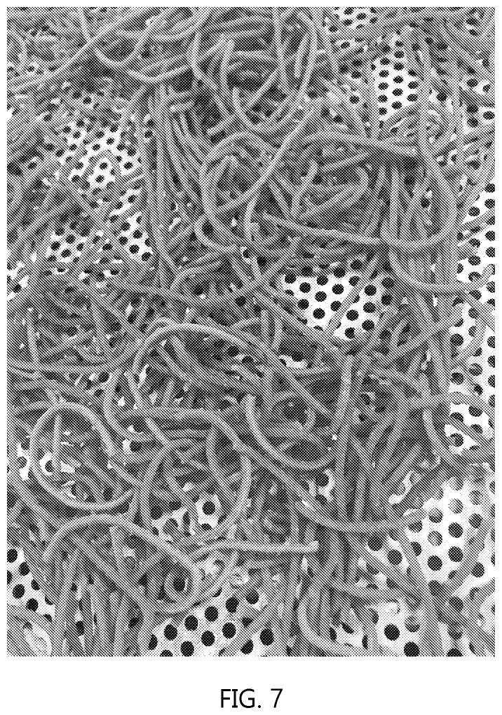

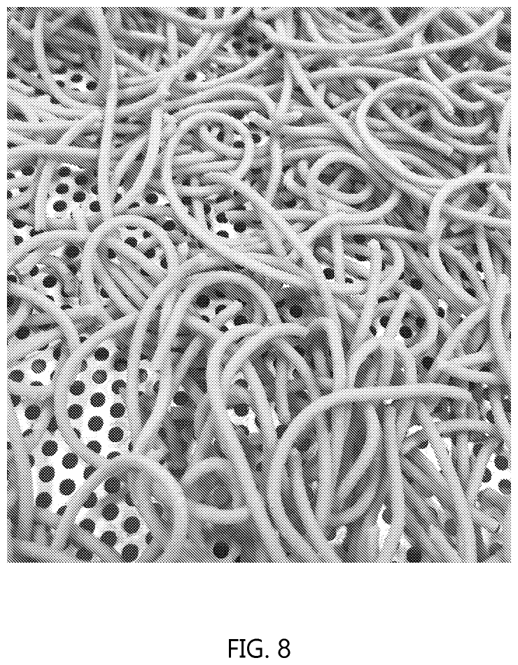

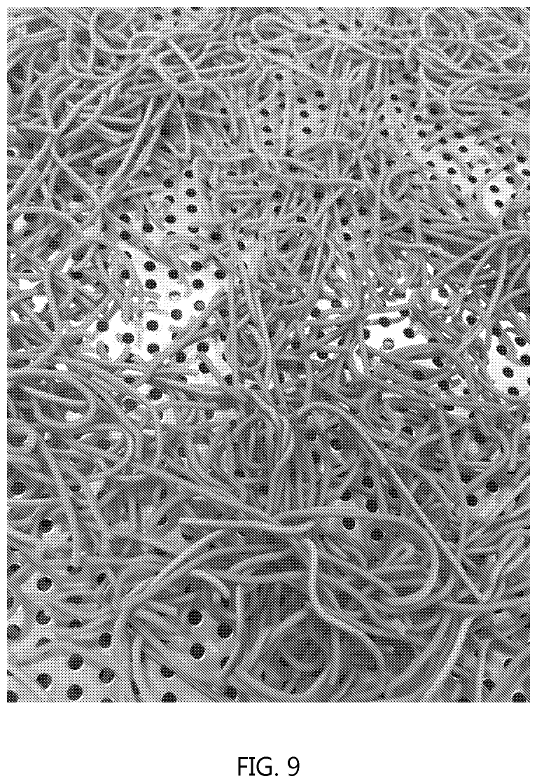

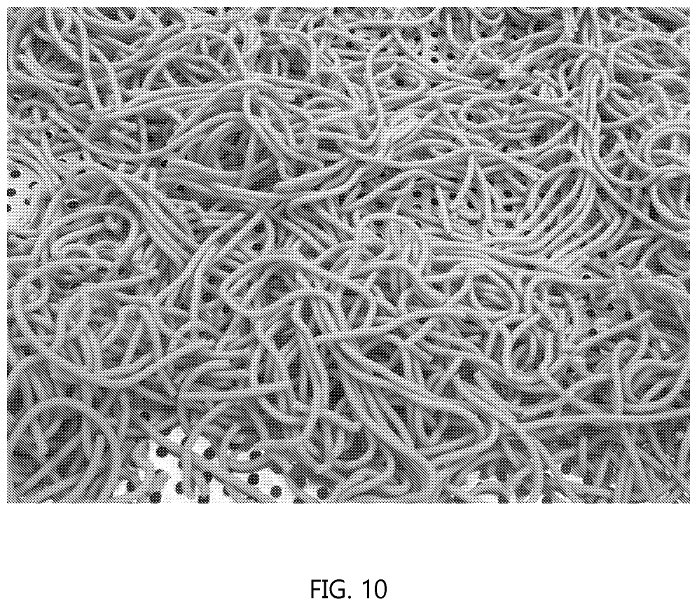

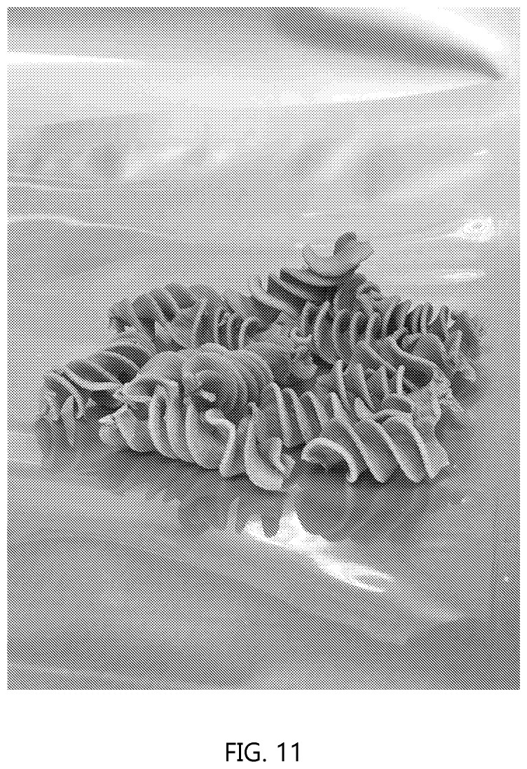

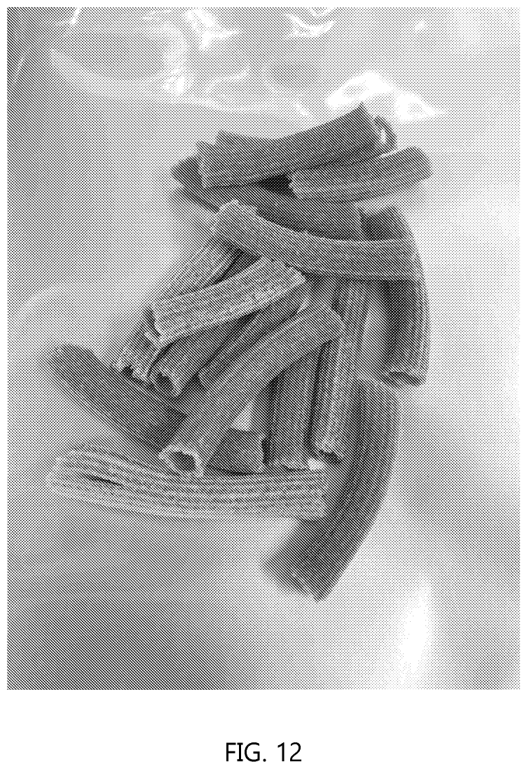

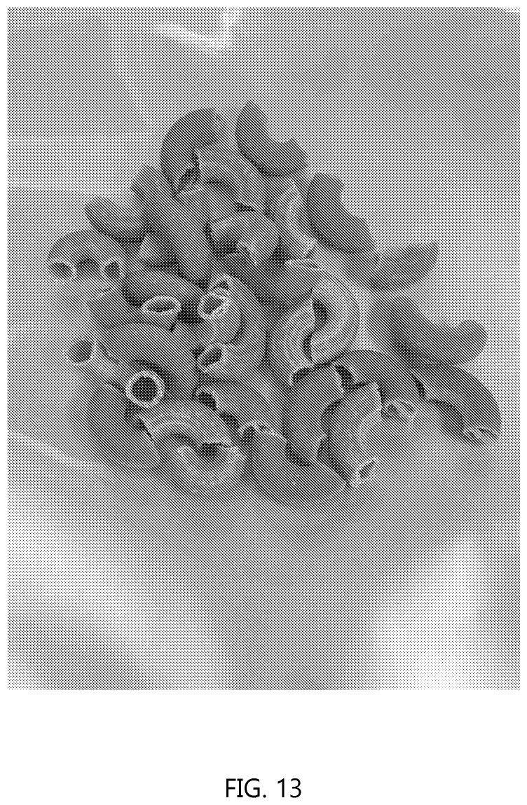

### DETAILED DESCRIPTION

Disclosed herein is a method for producing a plant-based high-protein pasta comprising at least about 50% pulse protein, by weight. The method produces pasta comprising at least about 55% protein, at least about 60% protein, at least about 65% protein, at least about 70% protein, etc. Products made by the method of the invention maintain a complete protein profile and clean label, and can be made in a wide variety of pasta shapes (e.g., spaghetti, macaroni, fusilli, lasagna, rigatoni) while still exhibiting classic pasta-like texture and shape. Pasta made according to the method of the invention also has a higher protein-to-carbohydrate ratio than that found in current commercially available high-protein pasta products.

The term “pasta” has a legal/regulatory definition. For example, in the United States the Food and Drug Administration defines “macaroni,” and “noodles,” with the definition of “macaroni” being found in 21 CFR 139.110 (a): “Macaroni products are the class of food each of which is prepared by drying formed units of dough made from semolina, durum flour, farina, flour, or any combination of two or more of these, with water and with or without one or more of the optional ingredients specified in paragraphs (a) (1) to (6), inclusive, of this section.” However, consumer dietary needs and preferences have resulted in a variety of changes to pasta formulations, so today “pasta” is also one of those terms for which it can be said that “I know it when I see it.” The present disclosure uses the term “pasta” to mean a composition that can be used to form macaroni and noodles having properties similar to those of similar products made using semolina, durum flour, etc. Those properties include elasticity, firmness, the ability to be extruded to form shapes that are essentially maintained after drying, boiling, etc.

The invention provides a method for producing plant-based high protein pastas, the method comprising the steps of admixing water, transglutaminase, and at least one plant protein to produce a water/transglutaminase/protein admixture that will form a gelatinized cake and processing the cake by extrusion to produce at least one gelatinized protein product. In various aspects, the method also comprises the step of drying the at least one gelatinized protein product at a drying temperature of from about 60 to about 400 degrees Celsius, to produce at least one plant-based high-protein pasta.

In various aspects of the invention, the ratio of water to protein in the water/transglutaminase/protein admixture comprises from about 40:60 to about 60:40. The effect of the amount of water in the original formula on the textural characteristics of rehydrated pasta is discussed, for example, in the Examples and Table 4 below. In various aspects, the transglutaminase is added at from about 0.001 percent to about 1 percent of the water/transglutaminase/protein admixture, by weight. In various aspects of the invention, the extrusion apparatus is a pasta extruder. The holding time for holding the admixture can be from about 0.5 to about 60 minutes, with those of skill in the art recognizing that the time can vary according to the amount of transglutaminase used.

In various aspects of the invention, the protein content of the resulting raw pasta is at least about 55 percent, at least about 60 percent, and even more preferably can be at least about 65 percent, at least about 70 percent, etc. In various aspects of the invention, the protein is pulse protein, and in various aspects the pulse is green/yellow pea (Pisum sativum). In various aspects of the invention the protein is provided in the form of at least one protein concentrate, at least one protein isolate, or a combination thereof (i.e., the protein is selected from the group consisting of at least one protein concentrate, at least one protein isolate, and combinations thereof). For example, pea protein isolate, pea protein concentrate, or any combination thereof can be used as the protein source.

According to the Food and Agriculture Organization of the United Nations, “pulses” are a type of leguminous crop that are harvested solely for their dry seeds (e.g., dried beans, lentils and peas), which generally would not include legumes used mainly for oil extraction, such as soybeans. Pisum sativum (garden pea, field pea, spring pea, English pea, common pea, green pea) is a pulse species cultivated in several countries as a source of protein. Tulbek et al. describe the cultivation, nutritional value, and processing of peas (Tulbek, M. C. et al. Pea: A Sustainable Vegetable Protein Crop, Sustainable Protein Sources (2017) p. 145-164). Although it had previously been reported that transglutaminase could be used to cross-link pea protein, Tulbek et al. also disclosed that “current research indicates that pea protein products tend to exhibit weaker gel strength, viscosity, and texture compared to egg, soy, and meat proteins.” However, the inventors have successfully utilized the cross-linking effects of transglutaminase to provide a type of gel that could be reduced in size and dried to produce a plant-based high protein pasta that could be used to create products in the shapes and textures of standard wheat-based pastas but with a 70% protein load, for example—5 times higher protein than standard wheat-based pastas and 40% higher than the highest high protein pasta products on the market. At these higher levels of protein, the protein-to-carbohydrate ratio is higher than 1:1, which is higher than that found in commercially-available high-protein pasta products.

The inventors chose to develop a method for producing these products that would not require the use of the most common method for producing high protein pasta products-high temperature, high pressure extrusion. The method of the invention is a more energy-efficient approach to the production of pasta from plant-based protein.

In the method of the invention, the inventors have used the combination of enzyme cross-linking, protein hydration, flavor, extrusion of the gel resulting from the hydration and cross-linking, and drying temperature to provide a clean-label product having a texture and consistency that is very similar to that of pasta. Although the resulting product is not primarily formed of flour, such as durum semolina, it will still be referred to herein as “pasta,” because it looks, tastes, and generally has a texture and consistency like the product that is classically defined as “pasta.”

Pasta has previously been made using pea flour, but it should be noted that pulse protein flours generally are reported to have from about 17 to about 30 percent protein, while pulse protein concentrates have from about 55 to about 60 percent protein and pulse protein isolates have from about 77 to about 85 percent protein. The composition of one commercially-available yellow pea flour (Mckenzie's Australian Yellow Pea Flour) is shown in Table 2.

TABLE 2
Yellow Pea Flour Composition, Per 100 g flour

| | | |
|---|---|---|
| Protein | 24.0 | g |
| Fat (total) | 2.6 | g |
| Carbohydrate | 62.8 | g |
| Dietary Fiber | 12.2 | g |

Clearly, the protein level of a pasta product made with pea flour would be significantly less than that of a pasta product made by the method of the invention, and the amount of carbohydrate, being over 60 percent, would have a significant impact on the properties of the pasta. According to the Northern Pulse Grower's Association, yellow pea flour, for example, contains 25-27% dietary fiber-both soluble and insoluble—the fiber being recommended as an acceptable substitute for a significant portion of wheat flour in products such as bakery products. The inventors have found a way to use pea protein, instead of pea flour, to produce pasta products having very significantly higher levels of protein, resulting in what is essentially a reversal of the protein-to-carbohydrate ratio found in currently-available commercial pasta products.

The term “extrusion” is used herein to describe the type of processing that is used to produce the gelatinized protein pasta product. However, it should be understood by those of skill in the art that the term is used broadly to describe extruding, pulverizing, crumbling, mashing, milling, crushing, grating, and other similar methods for reducing the size of a protein cake and forming smaller pieces of appropriate size and shape. For example, the product may be pressed through a metal plate comprising at least one aperture of desired shape, so that product pieces are formed as the product is pressed through the plate. Such a plate can be used as a die, providing at least one aperture of desired size and shape, to form pasta products of varying sizes and shapes. These may be desirable for producing a variety of different types of products.

Transglutaminase (2.3.2.13, protein-glutamine: amine y-glutamyl-transferase) cross-links proteins by transferring the y-carboxyamide group of the glutamine residue of one protein to the E-amino group of the lysine residue of the same or another protein. Transglutaminase is commonly used in the food industry for a variety of applications, and it can be produced by a variety of bacteria such as, for example, Streptomyces mobaraensis, Streptomyces libani, Bacillus circulans, Bacillus subtilis, Streptomyces ladakanum. In 1989, microbial transglutaminase was isolated from Streptoverticillium sp. Transglutaminase is often provided in powder form, particularly for large-scale use in the food industry, and is available from a variety of commercial providers. Suitable transglutaminase enzymes for use in the method of the invention include those of microbial origin which are widely available. For example, food-grade transglutaminase is marketed under trade names such as Activa® (Ajinomoto Foods) that are readily available in small quantities or large quantities for commercial-scale use.

The invention is described in various aspects as a method for producing products using pea protein. However, it should be clear to those of skill in the art that the method described herein may also be used for protein sources selected from the group consisting of pea protein concentrate, pea protein isolate, and other protein concentrates and isolates from other pulses such as red, green, yellow and brown lentils, chickpeas (chana or garbanzo beans), garden peas, black-eyed peas, runner beans, broad beans (fava beans) and kidney beans, for example. The method may also be used for proteins selected from the group consisting of rice protein isolate, rice protein concentrate, and soybean protein concentrate, soybean protein isolate, wheat protein concentrate, wheat protein isolate, teff protein concentrate, teff protein isolate, oat protein concentrate, oat protein isolate, corn protein concentrate, corn protein isolate, barley protein concentrate, barley protein isolate, sorghum protein concentrate, sorghum protein isolate, rye protein concentrate, rye protein isolate, millet protein concentrate, millet protein isolate, amaranth protein concentrate, amaranth protein isolate, buckwheat protein concentrate, buckwheat protein isolate, quinoa protein concentrate, quinoa protein isolate, and combinations thereof. However, pea is the plant protein highest in the amino acid leucine and it is also rich in arginine and lysine. Processing of pea protein requires significantly less water than processing soy and generates less CO2 than corn or rice processing, providing a more environmentally-sustainable option.

The method is simple, straightforward, and very cost-effective-requiring only the protein, enzyme, and optional flavor and spices with a few steps to prepare an exceptional high-protein pasta product. Briefly, the method can generally be performed by adding pea protein to a container in which the product can be mixed/stirred. Plant proteins, such as pea protein, for example, are commercially available as protein isolates or protein concentrates, for example, in powder form (or as liquid compositions comprising protein and water, for example).

Transglutaminase enzyme is added to and mixed into the pea protein. Optionally, flavor, spices, starches, carbohydrates, lipids, and other macro- and micronutrients can be added to enhance desired functional and/or nutritional characteristics. Tap water (at a temperature of about 55 degrees C.) is added to the protein/enzyme mixture with continued stirring for less than about 2 minute(s). The resulting cake is then formed into pasta using, for example, a pasta extruder. The shaped product is dried (e.g., by air-drying or convection heating) to produce a high-protein pasta product with a mild, neutral flavor.

To produce some formed pastas, it can be beneficial to combine protein and transglutaminase and at least one carbohydrate source and/or additional protein source which can serve as at least one binder for the textured protein (i.e., an “additive” to the textured plant protein). Transglutaminase is used at from about 0.001% to about 10%, by weight of dry ingredients. Suitable protein and carbohydrate sources include, for example, plant sources such as psyllium fiber, tapioca fiber, potato starch, and combinations thereof, and proteins such as rice protein, and combinations of proteins and carbohydrates. Fiber, another ingredient important to health-conscious consumers, can be present at up to about 15 percent (and preferably about 2 to 3 percent). The effects of these ingredients is shown in the Examples and in Tables 5-7 below.

The method of the invention can also be used to produce “instant” noodles. Instant noodles were originally developed in Japan in 1958, and their popularity has grown over the years to the point that the World Instant Noodles Association estimates that more than 100 billion servings of instant noodles are now consumed annually. In past years, their development goals have included taste, safety, convenience, preservability, and affordability. More recently, they have added nutrition and health, as well as eco-sustainability, to the list.

Products made by the method of the invention achieve all these goals and provide an easily stored, shipped, and prepared option for consumers around the world. To prepare instant noodles by the method of the invention, water, transglutaminase, and at least one plant protein are admixed to produce a water/transglutaminase/protein admixture that will form a gelatinized cake, and the cake is processed by extrusion to produce at least one noodle. To give the noodles their characteristic bite, firmness, and texture, partially hydrolyzed protein forms a part of the plant protein, and a carbonate compound (potassium carbonate and sodium carbonate form the traditional Kansui ingredient that is used in instant noodles such as ramen) is also added at from about 0.1 percent to about 1 percent. The dough formed by the gelatinized protein cake is extruded through a pasta extruder, and cut to form 1.5-1.7 mm noodles, for example, in order to form the at least one noodle. Noodles are steamed (e.g., for about 3 minutes), then fried (e.g., at 145 degrees Celsius for 2 minutes). Once cooled, they can be packaged. To rehydrate, noodles can be boiled for 3 minutes, for example (which can be done in a microwave).

The addition of low levels of hydrolyzed protein can also have a positive effect on the tensile strength, in general, of pasta produced according to the method of the invention. The degree of hydrolysis (DH) can be up to about 2.75 percent, a preferred 0.41% DH being preferred.

The present method, products made by the method, and pasta made using those products are described herein using the term “comprising.” However, it should be understood that “comprising” encompasses within its bounds the more narrowly-interpreted terms “consisting of” and “consisting essentially of.” The present method, products made by the method, and high protein pasta products made using those products can therefore also be described using those terms. Products made according to the method of the invention can be further described by means of the following non-limiting examples.

### Examples

Pea protein (Glanbia Pie., USA) and Transglutaminase, Activa STG (Ajinomoto Co., Inc., Japan) were used in making the High Plant Protein Pasta (HPPP). The pea protein has the following characteristics: protein content (>80% d.b), Ash (<7%) fat (<7%) and moisture (6% max).

### Optimization of Processing Conditions for the Production of TPP

Briefly, 500 g of pea protein was weighed using a digital weighing balance with 0.1 g precision (Model ML4002E, Mettler Toledo, Switzerland) into the mixing bowl of a stand mixer (Model KSM6573C0B, KitchenAid®, USA). The desired amount of additive was added to that and then the desired amount of transglutaminase was measured and added to the pea protein/additive mix. These ingredients were mixed together for 1 minute by setting the stirring rate of the KitchenAid® mixer to level 1. Tap water (55° C.) was measured and added to the mixture while stirring. The entire mixing operation, starting from the point of adding warm water to the admixture to when mixing action was stopped, was no longer than 1 minute. The dough was emptied into a hopper on the pasta extruder and pushed through a shaped die with moderate compressive force to form the desired pasta shape.

A pasta extruder comprises a holding area and a milling chamber. The milling chamber comprises a screw conveyor that is connected to an electric motor, cutting blade and a die/shaper (e.g., ¼-inch). The screw conveyor produces a clockwise movement that crushes the cake and transports it to the die located at the outlet of the milling chamber. As the screw conveyor presses the dough against the surface of the die, the cutting blade slices through the dough to cut the pasta to the desired length. The pasta formed by this method was spread onto perforated pans and dried in an industrial convective dryer (CO41408, MIWE condo, Arnstein Germany) with a preset temperature of between 100° F. and 350° F.

TABLE 3
Parameters for the Production of the Textured Plant Protein Pasta

| Parameters | Levels | | | | |
|---|---|---|---|---|---|
| Transglutaminase | 0.20 | 0.15 | 0.10 | 0.05 | 0.03 |
| Activa ® STG | | | | | |
| (% inclusion rate) | | | | | |
| Pea protein (g) | 400 g | | | | |
| Water (as a % of | 55 | | | | |
| total weight) | | | | | |

| | | | | |
|---|---|---|---|---|
| Additive (At | 80% Rice | Modified | Psyllium | Soluble |
| 5.5% of Total) | Protein | Potato | Fiber | Tapioca |
| | | Starch | | Fiber |

A milling die shape of ¼ inch was used to produce flat pasta sheets (1 mm×24 mm) for all ingredient combinations, and all pasta sheets were dried/cooked at 200 degrees Fahrenheit for 140 minutes.

In order to evaluate the high-protein pasta product (HPPP), 20 g of dried HPPP was added into 200 g boiled water in a beaker for 10 minutes holding duration. The water was removed by pouring the sample onto a screen with pore size of 600 μm. Samples were subsequently analyzed for taste, aroma, color, water absorption, texture profile analysis hardness, adhesiveness, cohesiveness, springiness, and chewiness. The dried HPPP was analyzed for amino acid, protein content, carbohydrate, ash and lipid content. The optimal HPPP was selected for the subsequent experiment.

### Water Absorption Index

The water absorption index testing procedure was adapted from an American Soybean Association technical bulletin (1988). This test analyzes the amount of water a textured protein product will absorb at a set weight of product and set time. Twenty grams of high protein pasta product was soaked in 100 ml of room temperature water for 20 minutes. After soaking, the hydrated product was drained on a screen for 5 minutes. The final weight was recorded. To calculate the Water Absorption Index, the following equation is used:

$$Water Absorption Index = \frac{Rehydrated wt . - Original Wt}{Original wt .}$$

### Tensile Strength Analysis

The textural properties of rehydrated samples were measured using a texture analyzer (TA-XT plus, Stable Micro Systems, UK). Two different probes were used, the TA-226 Tug Fixture and the Spaghetti Test Rig, to pull the hydrated pasta pieces apart. A piece of the HPPP was suspended between the two pieces of the fixture 1 mm/sec until 5 g resistance was sensed. The TA then sped up 3 mm/sec and continued until it moved 10 mm. Parameters obtained from the analysis included Stiffness, Firmness, Tensile Strength, and cohesiveness.

### Color Measurement

To consumers, the color of the pasta noodles indicates flavor and freshness. The dried and rehydrated HPPP were evaluated to look at the effect of hydration color of the product. The values of L* (lightness), a* (redness), b* (yellowness) C* (chroma) and °h (hue angle), were measured by the CIELAB color system using a colorimeter (Model 45/0, ColorFlex EZ USA). Prior to the analysis, the equipment was standardized using the white calibration plate. The colorimetric coordinate L* represents the lightness while the a* and b* represents the green to red and blue to yellow color ranges, respectively. Emphasis is generally placed on the b* when assessing pasta noodles, as it represents the color yellow.

### Amino Acid Composition

The complete amino acid profile was performed using the AOAC (1990). Amino acid composition of products made by the method of the invention were similar to those of commercially-available TPP products made using extrusion technology.

### Statistical Analysis

All experiments were performed in triplicate and data expressed as means+SD. The significant differences among means were determined by the analysis of variance (ANOVA) using Duncan's multiple comparisons at p: 50.05.

### Impact of Water and Additives on the Textural Properties of Hydrated Pasta

The impact of water added during initial production was determined by measuring the degree of stiffness, firmness, tensile strength and firmness for products produced using four different degrees of wetting (51.5%, 53.5%, 55%, 60%) and transglutaminase used to cross-link the protein (0.03%) The experiment was repeated 3 times, with the results being represented as the mean, with standard deviation. Results are shown in Table 4.

TABLE 4
Effect of Water Percentage on Textural
Characteristics of Rehydrated Pasta

| | |
|---|---|
| Parameter | Degree of Wetting |

| Tested | 51.5% | 53.5% | 55% | 60% |
|---|---|---|---|---|
| Stiffness | 620 | 1367 | 1865 | 2128 |
| Firmness | 34.63 | 32.61 | 12.05 | 16.66 |
| Tensile | 6.60 | 4.61 | 0.02* | 4.19 |
| Strength | | | | |
| Cohesiveness | 51.91 | 62.55 | 25.61 | 17.65 |

*Sample had multiple fracture points that allowed it to be pulled apart much easier than the toughness of the product in the mouth suggested.

The impact of insoluble additives added during initial production by measuring the degree of stiffness, firmness, tensile strength and firmness for products produced using three different insoluble additives (Rice Protein, Modified Tapioca Starch, Modified Potato Starch) and transglutaminase used to cross-link the protein (0.03%). The experiment was repeated 3 times, with the results being represented as the mean. Results are shown in Table 5.

TABLE 5
Effect of Insoluble Additives on Textural
Characteristics of Rehydrated Pasta

| | Insoluble Additive | | |
|---|---|---|---|
| Parameter | Rice | Modified | Modified |
| Tested | Protein | Tapioca Starch | Potato Starch |
| Stiffness | 575 | 18 | 21 |
| Firmness | 26 | 43 | 33 |
| Tensile Strength | 7 | 7 | 7 |
| Cohesiveness | 47 | 78 | 68 |

The impact of soluble additives added during initial production was determined by measuring the degree of stiffness, firmness, and tensile strength for products produced using three different insoluble additives (Psyllium Fiber, Corn Fiber, and Tapioca Fiber) and transglutaminase used to cross-link the protein (0.03%). The experiment was repeated 3 times, with the results being represented as the mean. Results are shown in Table 6.

TABLE 6
Effect of Soluble Additives on Textural
Characteristics of Rehydrated Pasta

| | Soluble Additive | | |
|---|---|---|---|
| Parameter | Psyllium | Corn | Tapioca |
| Tested | Fiber | Fiber* | Fiber |
| Stiffness | 1 | — | 1577 |
| Firmness | 39 | — | 14 |
| Tensile Strength | 5 | — | 2 |
| Cohesiveness | 54 | — | 16 |

*Piece did not form during the production process due to excessive dryness.

The impact of a combination of insoluble and soluble additives added during initial production by measuring the degree of stiffness, firmness, and tensile strength for products produced using six different combinations of insoluble and soluble additives (Rice Protein/Modified Potato Starch, Rice Protein/Psyllium Fiber, Rice Protein/Tapioca Fiber, Modified Potato Starch/Psyllium Fiber, Modified Potato Starch/Tapioca Fiber, Psyllium Fiber/Tapioca Fiber) and transglutaminase used to cross-link the protein (0.03%) The experiment was repeated 3 times. Results are shown in Table 7, with #1=rice protein/modified potato starch, #2=rice protein/psyllium fiber, #3=rice protein/tapioca fiber, #4=modified potato starch/psyllium fiber, #5=modified potato starch/tapioca fiber, and #6=psyllium fiber/tapioca fiber.

TABLE 7
Effect of Combined Soluble and Insoluble Additives
on Textural Characteristics of Rehydrated Pasta

Combination

| Parameter Tested | #1 | #2 | #3 | #4 | #5 | #6 |
|---|---|---|---|---|---|---|
| Stiffness | 15 | 32 | 23 | 792 | 21 | 1424 |
| Firmness | 32 | 35 | 44 | 24 | 25 | 24 |
| Tensile Strength | 6 | 4 | 7 | 4 | 5 | 3 |
| Cohesiveness | 52 | 61 | 81 | 39 | 44 | 26 |

### Basic Pasta Formula

Protein and activator were weighed, blended together. Water was added to the mixture at a temperature of about 52-54 degrees Celsius and mixed until the dough started to break up into smaller pieces. The dough was extruded through a pasta extruder, and pieces cut to the desired length. Formed pasta was then placed on perforated pans in a thin layer (1-1.5 lbs/full size pan) and baked at 200 degrees Fahrenheit until the moisture level was about 4-6% (about 1 hour and 40 minutes). The pasta was cooled and bulk-packaged in bags. The formula is shown in Table 8. ProFam® 580 is a pea protein available from Archer Daniels Midland with high gel strength, high solubility, and 80% protein content.

TABLE 8
Basic Pasta Formula

| | Base Formula Ingredients, | Percent Ingredient, |
|---|---|---|
| Ingredients | by Weight | by Weight |
| Water (50-52° C.) | 550.00 | 55.00% |
| ProFam ® 580 | 449.75 | 44.98% |
| Transglutaminase | 0.25 | 0.03% |

Pasta Formula with Hydrolyzed Protein

Pasta was produced by the same method as was used for the basic pasta formula, but 4.5 percent hydrolyzed protein was added to the mix as BarHarvest® 801, a partially-hydrolyzed pea protein produced by Glanbia Nutritionals, Twin Falls, Idaho. The formula is shown in Table 9.

TABLE 9
Ingredients for Pasta Made with Hydrolyzed Protein Added

| | Hydrolyzed Protein | |
|---|---|---|
| | Formula Ingredients, | Percent Ingredient, |
| Ingredients | by Weight | by Weight |
| Water (50-52° C.) | 550.00 | 55.00% |
| Profam ® 580 | 404.80 | 40.48% |
| BarHarvest ® 801 | 44.95 | 4.50% |
| Transglutaminase | 0.25 | 0.03% |

Pasta with Psyllium Fiber Added

Pasta was produced by the same method as was used for the basic pasta formula, but with the addition of 3.0 percent psyllium fiber. Ingredients are listed in Table 10.

TABLE 10
Ingredients for Pasta Made with Psyllium Fiber

| | Psyllium fiber Formula | Percent Ingredient, by |
|---|---|---|
| Ingredients | Ingredients, by Weight | Weight |
| Water (50-52° C.) | 550.00 | 55.00% |
| Profam ® 580 | 419.75 | 41.98% |
| Psyllium Fiber | 30.00 | 3.00% |
| Transglutaminase | 0.25 | 0.03% |

Pasta Made with the Addition of Citrus Fiber

Pasta was produced by the same method as was used for the basic pasta formula, but with the addition of 3.0 percent citrus fiber. Ingredients are listed in Table 11.

TABLE 11
Ingredients for Pasta Made with Citrus Fiber

| | Citrus Fiber Formula | Percent Ingredient, |
|---|---|---|
| Ingredients | Ingredients, by Weight | by Weight |
| Water (50-52° C.) | 550.00 | 55.00% |
| Profam ® 580 | 419.75 | 41.98% |
| Citrus Fiber | 30.00 | 3.00% |
| Transglutaminase | 0.25 | 0.03% |

### Pasta Made for Use as Instant Noodles

Ingredients were weighed and blended together. Kansui (potassium carbonate and sodium bicarbonate) was included in the formula for instant noodles, was 4.5 percent hydrolyzed pea protein (BarHarvest® 801). Water was added to the mixture at a temperature of about 52-54 degrees Celsius and mixing was performed until the dough started to break up into smaller pieces. The dough was extruded through a pasta extruder, and cut to form 1.5-1.7 mm noodles. Noodles were steamed for 3 minutes, then fried at 145 degrees Celsius for 2 minutes. To rehydrate, noodles were boiled for 3 minutes. Ingredients for the instant noodle formula are listed in Table 12.

TABLE 12
Ingredients for Pasta - Instant Noodles

| | Instant Noodle Formula | Percent Ingredient, |
|---|---|---|
| Ingredients | Ingredients, by Weight | by Weight |
| Water (50-52° C.) | 550.00 | 55.00% |
| Profam ® 580 | 401.80 | 40.18% |
| BarHarvest ® 801 | 44.95 | 4.50% |
| Kansui | 3.00 | 0.30% |
| Transglutaminase | 0.25 | 0.03% |

### Impact of Inclusion of Ingredients on Pasta Hydration

Various formulas were tested to determine the absorption index of the pasta when ingredients such as rice protein, potato starch, psyllium fiber, or tapioca fiber were added to the pasta ingredients. Samples containing 0.2% Tg/5.5% Rice Protein, 0.2% Tg/5.5% Modified Potato Starch, 0.2% Tg/5.5% Psyllium Fiber, 0.2% Tg/5.5% Soluble Tapioca Fiber, 0.15% Tg/5.5% Rice Protein, 015% Tg/5.5% Modified Potato Starch, 015% Tg/5.5% Psyllium Fiber, 0.15% Tg/5.5% Soluble Tapioca Fiber, 0.10% Tg/5.5% Rice Protein, 0.10% Tg/5.5% Modified Potato Starch, 0.10% Tg/5.5% Psyllium Fiber, or 0.10% Tg/5.5% Soluble Tapioca Fiber Samples were too brittle to form through the extruder and either crumbled to pieces coming out of the extruder or crumbled as they were being laid out on the tray for drying. However, other combinations were successful and were tested to determine the absorption index. Results are shown in Table 13.

TABLE 13
Pasta Hydration (Absorption Index) by Ingredient Addition

| Ingredient Combination Added | Absorption |
|---|---|
| to Pea Protein/Water Mix | Index (%) |
| 0.03% Tg/5.5% Rice Protein | 58.70%^{ab} |
| 0.03% Tg/5.5% Soluble Tapioca Fiber | 63.18%^{b} |
| 0.03% Tg/5.5% Modified Potato Starch | 76.71%^{c} |
| 0.03% Tq/5.5% Psvllium Fiber | 137.29%^{d} |
| 0.05% Tg/5.5% Rice Protein | 53.01%^{a} |
| 0.05% Tg/5.5% Soluble Tapioca Fiber | 60.21%^{ab} |
| 0.05% Tg/5.5% Modified Potato Starch | 71.03%^{c} |
| 0.05% Tq/5.5% Psyllium Fiber | 135.59%^{d} |

The values with different superscript letters in a column are significantly different (p < 0.05).

### Impact of Ingredients on Pasta Color

The impact of the addition of various ingredients on pasta color was determine using CIELAB color system using a colorimeter (Model 45/0, ColorFlex EZ USA), and values generated as described above. Samples containing 0.2% Tg/5.5% Rice Protein, 0.2% Tg/5.5% Modified Potato Starch, 0.2% Tg/5.5% Psyllium Fiber, 0.2% Tg/5.5% Soluble Tapioca Fiber, 0.15% Tg/5.5% Rice Protein, 015% Tg/5.5% Modified Potato Starch, 015% Tg/5.5% Psyllium Fiber, 0.15% Tg/5.5% Soluble Tapioca Fiber, 0.10% Tg/5.5% Rice Protein, 0.10% Tg/5.5% Modified Potato Starch, 0.10% Tg/5.5% Psyllium Fiber, or 0.10% Tg/5.5% Soluble Tapioca Fiber Samples were too brittle to form through the extruder and either crumbled to pieces coming out of the extruder or crumbled as they were being laid out on the tray for drying. However, other combinations, shown in Table 14, provided pastas with the desired taste and texture, etc. Color measurements are provided in Table 14.

TABLE 14
Pasta Color by Ingredient Addition

| Ingredient Combination | | | | | | |
|---|---|---|---|---|---|---|
| Added to Pea | Dry | Dry | Dry | Hydrated | Hydrated | Hydrated |
| Protein/Water Mix | L* | a* | b* | L* | a* | b* |
| 0.03% Tg/5.5% | 50.07^{a} | 12.35^{ae} | 26.93^{acd} | 50.27^{a} | 10.43^{ac} | 24.65^{a} |
| Rice Protein | | | | | | |
| 0.03% Tg/5.5% Soluble | 49.52^{a} | 13.58^{b} | 28.4^{bd} | 51.19^{b} | 10.31^{abc} | 19.78^{bd} |
| Tapioca Fiber | | | | | | |
| 0.03% Tg/5.5% | 55.49^{b} | 10.66^{cd} | 26.16^{c} | 54.54^{c} | 7.5^{d} | 21.21^{c} |
| Modified Potato Starch | | | | | | |
| 0.03% Tg/5.5% | 47.99^{c} | 11.64^{ac} | 27.00^{acd} | 56.07^{d} | 7.05^{e} | 19.63^{b} |
| Psvllium Fiber | | | | | | |
| 0.05% Tg/5.5% | 49.71^{a} | 11.77^{ac} | 26.55^{a} | 50.61^{ab} | 10.64^{c} | 25.41^{e} |
| Rice Protein | | | | | | |
| 0.05% Tg/5.5% Soluble | 48.20^{c} | 13.27^{be} | 27.86^{d} | 48.7^{e} | 10.16^{ab} | 20.11^{d} |
| Tapioca Fiber | | | | | | |
| 0.05% Tg/5.5% | 53.93^{d} | 10.23^{d} | 25.89^{bc} | 52.92^{f} | 9.16^{f} | 20.62^{f} |
| Modified Potato Starch | | | | | | |
| 0.05% Tg/5.5% | 47.65^{c} | 11.45^{ac} | 26.91^{acd} | 55.28^{g} | 10.01^{b} | 19.79^{bd} |
| Psyllium Fiber | | | | | | |

The values with different superscript letters in a column are significantly different (p < 0.05).

Tensile Strength and Textural Profile Analysis of Pasta Made with Rice Protein, Soluble Tapioca Fiber, Modified Potato Starch, or Psyllium Fiber

The textural properties of rehydrated samples of pastas made using various ingredient combinations were measured using a texture analyzer (TA-XT plus, Stable Micro Systems, UK). Two different probes were used, the TA-226 Tug Fixture and the Spaghetti Test Rig, to pull the hydrated pasta pieces apart. A piece of the HPPP was suspended between the two pieces of the fixture 1 mm/sec until 5 g resistance was sensed. The TA then sped up 3 mm/sec and continued until it moved 10 mm. Parameters obtained from the analysis included Stiffness, Firmness, Tensile Strength, and cohesiveness. Results for tensile strength are listed in Table 15. Results for texture profile analysis (TPA) are listed in Table 16. Means that do not share a superscript in each table are significantly different.

TABLE 15
Tensile Strength and Textural Profile Analysis of
Pasta Made with Rice Protein, Soluble Tapioca Fiber,
Modified Potato Starch, or Psyllium Fiber

| | Firmness | Tensile Strength |
|---|---|---|
| | (g force) | (mm Traveled) |
| 0.03% Tg/5.5% Rice Protein | 26.08^{ac} | 7.09^{a} |
| 0.03% Tg/5.5% Soluble Tapioca Fiber | 43.96^{b} | 6.62^{a} |
| 0.03% Tg/5.5% Modified Potato Starch | 33.28^{abcd} | 7.00^{a} |
| 0.03% Tg/5.5% Psyllium Fiber | 21.57^{c} | 5.15^{a} |
| 0.05% Tg/5.5% Rice Protein | 33.29^{abcd} | 6.17^{a} |
| 0.05% Tg/5.5% Soluble Tapioca Fiber | 27.02^{ac} | 6.17^{a} |
| 0.05% Tg/5.5% Modified Potato Starch | 46.23^{bd} | 7.25^{a} |
| 0.05% Tg/5.5% Psyllium Fiber | 35.45^{ab} | 7.52^{a} |

The values with different superscript letters in a column are significantly different (p < 0.05).

TABLE 16
Textural Profile Analysis of Pasta Made with Rice Protein, Soluble
Tapioca Fiber, Modified Potato Starch, or Psyllium Fiber

| Ingredient | | | | | |
|---|---|---|---|---|---|
| Combination Added to | Hardness | Adhesiveness | Cohesiveness | Springiness | Chewiness |
| Pea Protein/Water Mix | (g force) | (g/sec) | (%) | (%) | (g force) |
| 0.03% Tg/5.5% | 9445.3^{ac} | −13.812^{abc} | 70.52%^{a} | 84.63%^{a} | 5540.39^{a} |
| Rice Protein | | | | | |
| 0.03% Tg/5.5% | 9430.10^{ac} | −34.8^{abc} | 72.56%^{a} | 81.4%^{a} | 5385.52^{a} |
| Soluble Tapioca Fiber | | | | | |
| 0.03% Tg/5.5% | 9079.10^{abc} | −8.665^{b} | 69.98%^{a} | 81.54%^{a} | 5150.74^{a} |
| Modified Potato Starch | | | | | |
| 0.03% Tg/5.5% | 5762.00^{b} | −39.77^{c} | 27.8%^{b} | 76.892%^{a} | 1256.74^{b} |
| Psyllium Fiber | | | | | |
| 0.05% Tg/5.5% | 11623.94^{c} | −6.56^{ab} | 66.38%^{ac} | 87.12%^{a} | 6663.41^{a} |
| Rice Protein | | | | | |
| 0.05% Tg/5.5% | 10310.47^{a} | −29.99^{abc} | 74.18%^{a} | 82.84%^{a} | 5756.9^{a} |
| Soluble Tapioca Fiber | | | | | |
| 0.05% Tg/5.5% | 10278.65^{a} | −7.25^{ab} | 72.65%^{a} | 83.47%^{a} | 5726.01^{a} |
| Modified Potato Starch | | | | | |
| 0.05% Tg/5.5% | 6400.32^{ab} | −32.49^{abc} | 39.42%^{bc} | 77.96%^{a} | 2514.35^{b} |
| Psyllium Fiber | | | | | |

The values with different superscript letters in a column are significantly different (p < 0.05).

Although the foregoing specification and examples fully disclose and enable the present invention, they are not intended to limit the scope of the invention, which is defined by the claims appended hereto.

All publications, patents and patent applications are incorporated herein by reference. While in the foregoing specification this invention has been described in relation to certain embodiments thereof, and many details have been set forth for purposes of illustration, it will be apparent to those skilled in the art that the invention is susceptible to additional embodiments and that certain of the details described herein may be varied considerably without departing from the basic principles of the invention.

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for producing a high-protein pasta product, the method comprising the steps of
(a) admixing water, transglutaminase, and at least one plant protein composition selected from the group consisting of protein isolate, protein concentrate, and combinations thereof, to produce a water/transglutaminase/protein admixture that forms a gelatinized protein cake; and
(b) processing the gelatinized protein cake by extrusion to produce a formed protein pasta product.

2. The method of claim 1, further comprising a step (c) drying the formed protein pasta product at a drying temperature of from about 60 to about 300 degrees Celsius, to produce a low moisture, shelf-stable high protein pasta product.

3. The method of claim 1, wherein the plant protein is pulse protein.

4. The method of claim 3, wherein the pulse protein is selected from the group consisting of at least one isolate, at least one concentrate, or a combination thereof, from Pisum sativum.

5. The method of claim 1, wherein the holding admixture is held for a period of from 0.5 minutes to about 60 minutes to allow the gelatinized protein cake to form before it is processed according to step (b).

6. The method of claim 1, wherein the ratio of water to pea protein in the admixture comprises from about 60:40 to about 40:60.

7. The method of claim 1, wherein the transglutaminase is added at from about 0.001 percent to about 10 percent of the admixture, by weight.

8. The method of claim 1, wherein the transglutaminase is present at from about 0.01% to about 10%, by weight.

9. The method of claim 1, wherein the transglutaminase is a microbial transglutaminase.

10. The method of claim 1, wherein the extrusion is performed using a pasta extruder.

11. The method of claim 1, wherein the plant protein is selected from the group consisting of proteins from red lentils, green lentils, yellow lentils, brown lentils, chickpeas, garden peas, black-eyed peas, runner beans, fava beans, kidney beans, and combinations thereof.

12. A high-protein pasta product comprising at least 70 percent pulse protein.

13. The high-protein pasta product of claim 12, wherein the pulse protein is gelatinized by crosslinking the protein with transglutaminase.

14. The high-protein pasta product of claim 12, wherein the pulse protein comprises at least one isolate, at least one concentrate, or a combination thereof, from Pisum sativum.
